(19) United States
(12) Patent Application Publication
(10) Pub. No.: US 2011/0011202 A1
(43) Pub. Date: Jan. 20, 2011

(54) Bicycle crank

(75) Inventor: Sheng-Yuan Lin, Taichung (TW)

Correspondence Address: LEE, CHEN-HSIAO, P.O. BOX 215,, TAICHUNG, 40099, TW

(73) Assignee: LEE, CHEN-HSIAO

(21) Appl. No.: 12/588,281

(22) Filed: Oct. 9, 2009

(30) Foreign Application Priority Data
Jul. 17, 2009 (TW) 098213131

(51) Int. Cl. B62M 3/00

(52) U.S. Cl. 74/594.1

(57) ABSTRACT

A bicycle crank comprises an L-type left crank and an L-type right crank. The L-type left/right cranks are respectively and integrally composed of a crank and a connection head, and includes a through hole passing through the crank and the connection head, a left compression shaft and a right compression shaft respectively disposed to terminals of the through holes of the L-type left/right cranks, a cone shaped member in which two ends are respectively disposed in the left and right compression shafts and the inner surface has screw threads, a rotary sleeve that is a hollow and integrally formed, and two locking members in which a terminal has screw threads corresponding to the cone shaped member and for respectively passing through the through holes and locked to two ends of the cone shaped member to connect the L-type left crank and the L-type right crank.

### FIELD OF THE INVENTION

The invention relates to a bicycle crank, and more particularly to a bicycle crank that is integrally composed of an L-shaped left crank and an L-shaped right crank incorporated with compression shafts, a cone shaped member and locking members to achieve the bicycle crank having rigidity and durable effect, and a stable entire structure without easily breaking.

### BACKGROUND OF THE INVENTION

Since modern people are very busy, most of them always drive cars for their duties in hurry and are unable to enjoy any leisure activity for relaxing pressures resulted from works. Nevertheless, everybody gradually recognizes the importance of leisure activities on health. Many outdoor scenic spots develop cycling. Bicycles have played an important role in outdoor activities for leisure exercises.

However, a conventional bicycle crank adopts connection manner. As shown in FIG. 1, a schematic diagram of a conventional bicycle crank structure is shown. The conventional bicycle crank is serially connected and assembled by a crank 10 and a connection head 12 as a connection crank. The connection screws (not shown in the figure) of the connection head and the crank may be twisted and deformed after stepping on pedals pivotally connected to the crank structure. Consequently, the pedals connected to the crank structure cannot be smoothly stepped on or may become rusty or be easily broken, and furthermore the crank structure may endanger the user safety due to worse material quality.

In addition, according to the disclosed technique of US publication patent US20070295154, entitled as “Crankset Assembly for A Bicycle”, the case disclosed a first crank and a second crank that are symmetry. Connection portions are respectively extended from each one end of the first crank and the second crank. An external periphery at a terminal of the connection portion forms a polygonal cloud portion. An end of a first rotary sleeve is provided for fitting the connection portion of the first crank where another end forms a first wave teeth. A terminal inside the first wave teeth is fit with a first nut having a circular hole. An end of a second rotary sleeve is provided for fitting the connection portion of the second crank where another end forms a second wave teeth that is provided for engaging with the first wave teeth. Moreover, a terminal inside the second wave teeth is fit with a second nut having inner screw holes. A screw bolt is locked to the inner screw hole of the second nut by passing through the circular hole from the first rotary sleeve so as to assemble the first rotary sleeve and the second rotary sleeve as a whole. The shortcomings of the publication structure are shown as the following:
1. Corresponding insides of the first and second rotary sleeves must be processed to produce wave teeth so that slip and idle running may not happen after the two part are assembled, thus consequently causing complicated processing procedure and high manufacturing cost.
2. Further, the goal of integrally connecting the first and second rotary sleeves may be achieved by means of mutually locking the first and second nuts and the screw bolts, thus causing many assembly components, time consuming and strenuous effort in installation.
3. The connection portion of the side of the first crank connected to the inside of the corresponding side of the first rotary sleeve and the connection portion of the second crank connected to the inside of the corresponding side of the second rotary sleeve adopt the fitting way. Consequently, it may still cause inaccurate connection. The crankset assembly may come off the bicycle to increase the potential dangers once the bicycle often passes through bumpy roads.

Therefore, to overcome the foregoing shortcomings, the inventor(s) of the invention based on years of experience in the related field to conduct extensive researches and experiments for the crank structure, and finally invented a bicycle crank.

### SUMMARY OF THE INVENTION

A primary objective of the invention is to provide a bicycle crank, wherein its L-shaped crank is integrally composed of a crank and a connection head to improve the product quality and to achieve solid and durable condition and may not be easily broken. In addition, a compression shaft, a cone shaped member, and locking members are mutually incorporated to ensure that the L-shaped crank can approach the center place of a sleeve to stabilize the entire structure.

A second objective of the invention is to provide a bicycle crank that utilizes a composite material to form an L-shaped crank.

According to the foregoing objectives, the bicycle crank comprises symmetric L-shaped cranks. The symmetric L-shaped cranks are an L-shaped left crank and an L-shaped right crank. Every L-shaped left crank and the L-shaped right crank are integrally formed by a crank and a connection head and each comprise a through hole that passes through the crank and the connection head. A left compression shaft and a right compression shaft are respectively accommodated into the terminals of the through holes of the L-shaped left crank and the L-shaped right crank. An end of a cone shaped member is accommodated to the right compression shaft where another end is accommodated in the left compression shaft. The inner surface of the cone shaped member has screw threads. A rotary sleeve is a hollow shape and integrally formed. One end of the rotary sleeve is connected to the connection head of the L-shaped right crank where another end is connected to the connection head of the L-shaped left crank. The rotary sleeve is used to connect the L-shaped left crank and the L-shaped right crank for connection.

### BRIEF DESCRIPTION OF THE DRAWINGS

FIG. 1 is a schematic diagram of a conventional crank structure;

FIG. 2 is a perspective view according to an embodiment of the invention;

FIG. 3 is a component decomposition drawing according to an embodiment of the invention;

FIG. 4 is a decomposed cross-sectional view according to an embodiment of the invention; and

FIG. 5 and FIG. 6 are assembly drawings according to an embodiment of the invention.

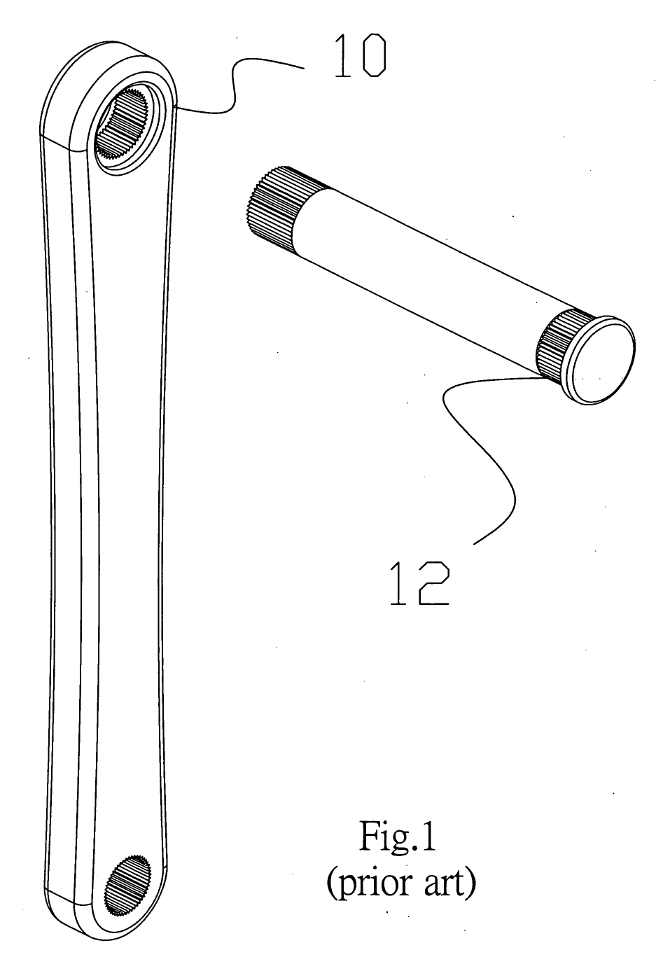

### DETAILED DESCRIPTION OF THE PREFERRED EMBODIMENTS

Other features and advantages of the present invention will become apparent from the following description of the invention which refers to the accompanying drawings.

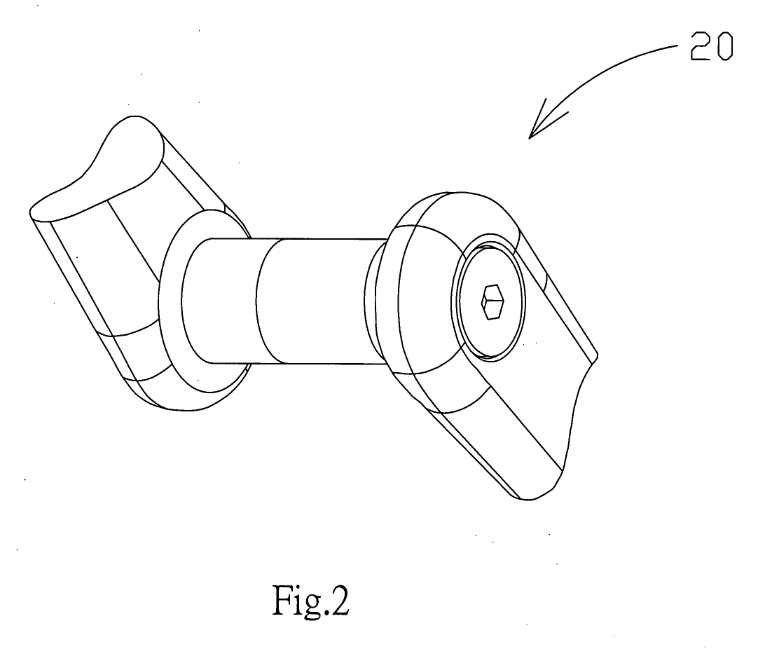

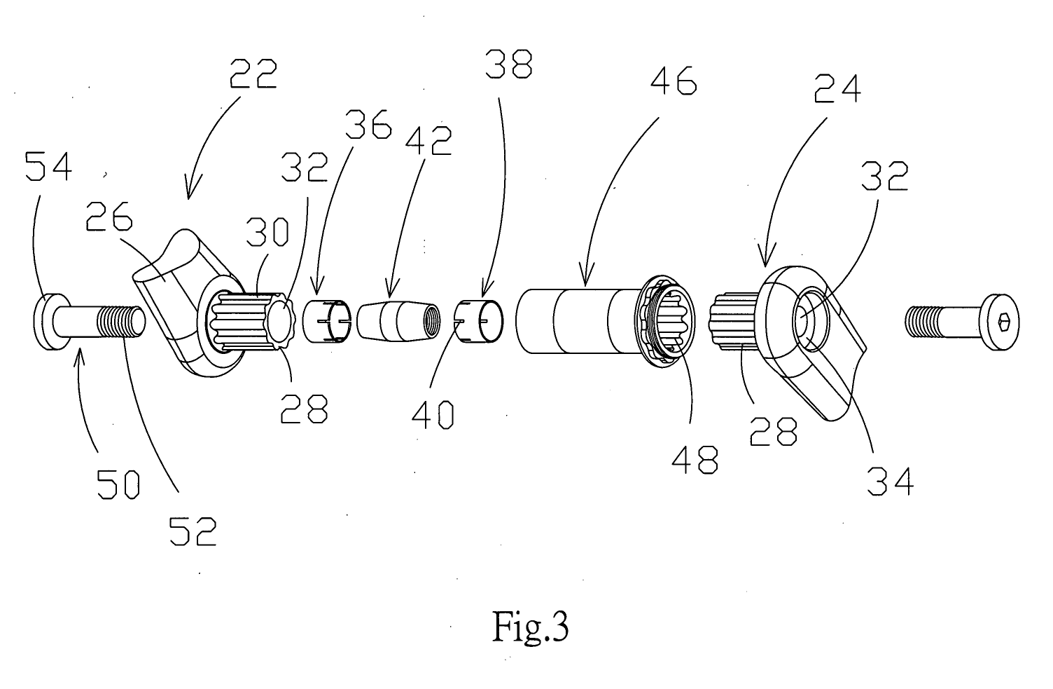

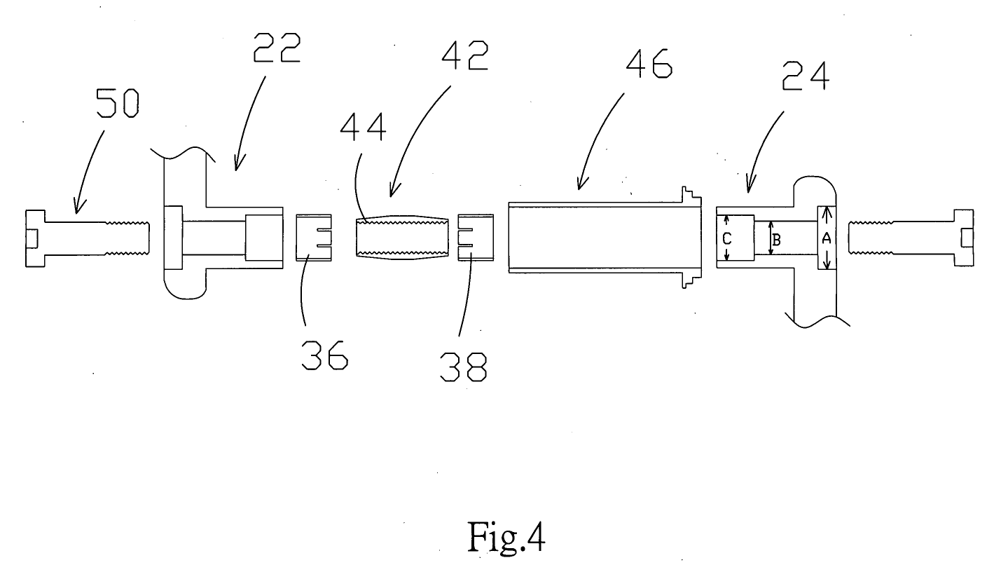

Please refer to FIG. 2 to FIG. 6, a three-dimensional diagram, a decomposition drawing, a decomposed cross-sectional view, assembly drawings are respectively shown according to an embodiment of the invention.

Firstly, as shown in the figures, the bicycle crank 20 of the invention comprises an L-shaped left crank 22 and an L-shaped right crank 24 which are symmetrical. Every L-shaped left crank 22 and the L-shaped right crank 24 comprise a crank 26 and a connection head 28 connected to one end of the crank 26. The crank 26 and the connection head 28 are integrally formed. Another end of the crank 26 is connected to a pedal (not shown in the figure). In addition, an outer periphery of the connection head 28 is a first polygonal cloud portion 30.

Moreover, every L-shaped left crank 22 and the L-shaped right crank 24 each comprises a through hole 32 passing through the crank 26 and the connection head 28. The aperture diameter of the through hole is divided into three parts. The front aperture diameter is A, the aperture diameter of the middle section is B, and the bottom aperture diameter is C, wherein the aperture diameter A is greater than the aperture diameter B, and the aperture diameter C is greater than the aperture diameter C. The through hole 32 forms a positioning flange 34 at the aperture diameter A that is shrunk to the aperture diameter B.

A left compression shaft 36 and a right compression shaft 38 are respectively accommodated to last ends (the aperture diameter C) of the through holes 32 of the L-shaped left crank 22 and the L-shaped right crank 24. An end of the left compression shaft 36 and one end of the right compression shaft 38 each has a plurality of notches 40 to provide proper deformation spaces for the L-shaped left crank 22 and the L-shaped right crank 24.

An end of a cone shaped member 42 is accommodated in the right compression shaft 38 where another end is accommodated in the left compression shaft 36. An inner surface of the cone shaped member 42 has screw threads 44. A rotary sleeve 46 is hollow and integrally formed. An end of the rotary sleeve 46 is connected to the connection head 28 of the L-shaped right crank 24 where another end is connected to the connection head 28 of the L-shaped left crank 22. Inner circumferences of two ends of the rotary sleeve 46 respectively comprises a second polygonal cloud portion 48 corresponding to the first polygonal cloud portion 30 to align the first polygonal cloud portions 30 of the L-shaped left crank 22 and the L-shaped right crank 24. The rotary sleeve 46 connected to the L-shaped left crank 22 and the L-shaped right crank 24 is provided for combining with a driving position of the bicycle. Terminals of two T-shaped locking members 50 have screw threads 52 correspond to the inner screw threads 44 of the cone shaped member 42. The T-shaped locking members 50 respectively pass through the through holes 32, and are locked to two ends of the cone shaped member 42 to connect the L-shaped left crank 22 and the L-shaped right crank 24.

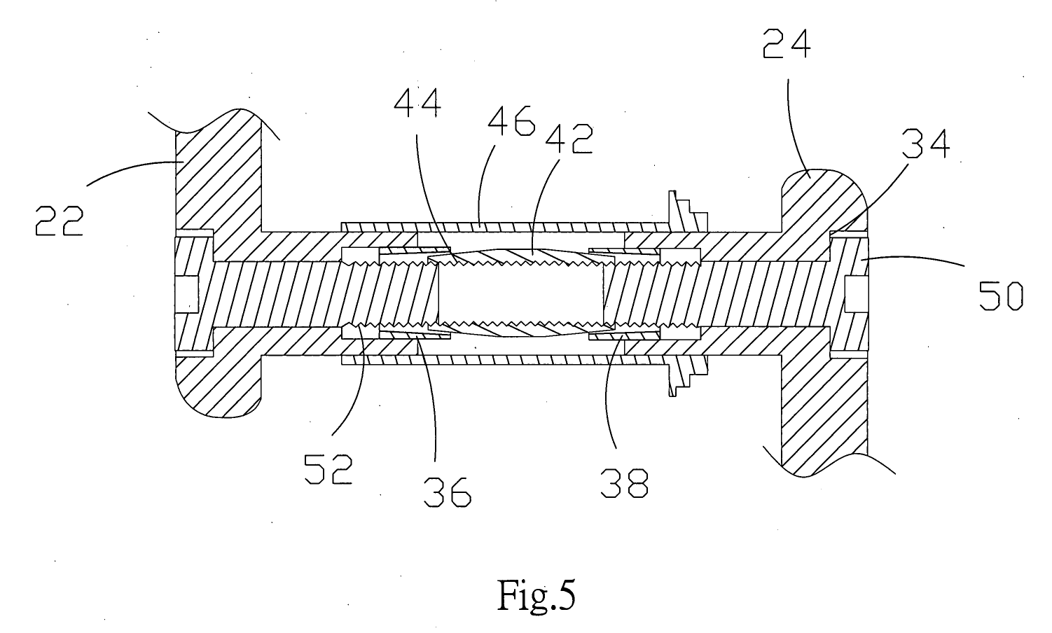

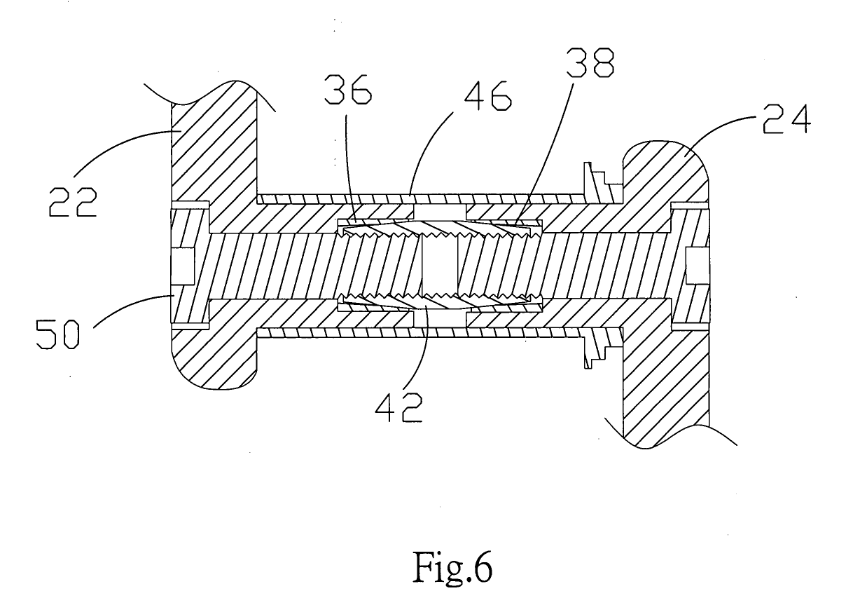

Referring to FIG. 5 and FIG. 6, movement schematic diagrams shows that the L-shaped left crank and the L-shaped right crank are connected through the T-shaped locking members respectively passing through the through holes and locked to the two ends of the cone shaped members. As shown in the figures, front protruding portions 54 of the T-shaped locking members 50 lean against the positioning flanges 34 of the through holes 32. When the two T-shaped locking members 50 are respectively and gradually locked inside the cone shaped member 42, the L-shaped left crank 22 and the L-shaped right crank 24 are respectively driven to lock toward the center of the cone shaped member 42. At the time, after the left compression shaft 36 and the right compression shaft 38 are squeezed by the cone shaped member 42, the stability between the cone shaped member 42 and the rotation sleeve 46 is further enhanced.

In addition, the L-shaped left crank and the L-shaped right crank is integrally composed of a composite material.

The foregoing illustration is the related structures, positions and assemblies of each component of the bicycle crank shown in the invention. Next, the implement effects and the features of the invention expectedly achieved are illustrated as the followings.
1. The rotary sleeve of the invention is specifically and integrally made. By comparing with the conventional structure composed of first and second rotary sleeves, the invention improves the substantial effects of enhancing the structural strength, simplifying the process, providing the low production cost, and eliminating the unnecessary connection components.
2. The connection heads of the symmetric L-shaped cranks have stage through holes fit by a locking member from the outside. After the connection heads of the symmetric L-shaped cranks are respectively inserted into the two corresponding exterior insides of the rotary shafts, the locking members at two sides are respectively locked to the corresponding threads of the cone shaped member disposed into the rotary sleeve so that the symmetric L-shaped cranks can be connected into a whole through the cone shaped member and the two locking members to increase the structural rigidity and to prevent the connections and the rotary sleeve from coming off. Accordingly, the invented technique is better than the structural feature disclosed in US publication patent US20070295154A1.

Accordingly, the bicycle crank of the invention uses L-type cranks integrally composed of the crank and the connection heads to improve the deformation of the engaging opening caused by using the bicycle crank for long time so as to achieve the rigidity and durable effect, and furthermore the compression shaft, the cone shaped member and the locking members are utilized to ensure that the L-shaped crank can be close to the center of the rotary sleeve to enhance the stability.

Although the features and advantages of the embodiments according to the preferred invention are disclosed, it is not limited to the embodiments described above, but encompasses any and all modifications and changes within the spirit and scope of the following claims.

What is claimed is:

1. A bicycle crank comprising:
a symmetric L-shaped crank integrally composed of a crank an a connection head; and
a rotary sleeve being a hollow state and integrally formed, wherein two ends are provided for fitting and positioning the connection head of the symmetric L-shaped crank.

2. The bicycle crank as claimed in claim 1, wherein the symmetric L-shaped crank has an L-shaped left crank and an L-shaped right crank.

3. The bicycle crank as claimed in claim 1, wherein an outer periphery of the connection head of the symmetric L-shaped crank includes a first polygonal cloud portion, and an inner periphery of two ends of the rotary sleeve has a second polygonal cloud portion corresponding to the first polygonal cloud portion for closely connecting each other.

4. The bicycle crank as claimed in claim 1, wherein the symmetric L-shaped cranks further comprise through holes passing through the crank and the connection head; a cone shaped member disposed between connection heads of the symmetric L-shaped cranks, wherein and an inner surface of the cone shaped member has screw threads; and two locking members respectively fit to the through holes of the symmetric L-shaped cranks, wherein terminals of the locking members have screw threads for screwing the screw threads of the cone shaped member.

5. The bicycle crank as claimed in claim 4, wherein a left compression shaft and a right compression shaft are respectively disposed between terminals of the through holes and corresponding ends of the cone shaped member in the symmetric L-shaped crank.
